(19) United States
(12) Patent Application Publication
(10) Pub. No.: US 2024/0408859 A1
(43) Pub. Date: Dec. 12, 2024

(54) BIODEGRADABLE LAMINATING FILM AND CONTAINER MADE OUT OF IT

(71) Applicant: SOCIETE DES PRODUITS NESTLE S.A., Vevey (CH)

(72) Inventors: DAVID NORDQVIST, Echichens (CH); FREDERIC DOLEAC, Vaux et Chantegrue (FR); EMMANUEL CROISIER, Lonay (CH)

(21) Appl. No.: 18/695,431

(22) PCT Filed: Sep. 16, 2022
(86) PCT No.: PCT/EP2022/075722

§ 371 Date: Mar. 26, 2024

(30) Foreign Application Priority Data
Sep. 28, 2021 (EP) 21199291.2

(51) Int. Cl. B32B 27/36; B32B 7/12; B32B 27/08; B32B 33/00; B32B 37/12; B32B 37/14

(52) U.S. Cl. CPC B32B 27/36; B32B 7/12; B32B 27/08; B32B 33/00; B32B 37/12; B32B 2037/1276; B32B 2037/148; B32B 2250/02; B32B 2250/244; B32B 2255/10; B32B 2264/1027; B32B 2264/104; B32B 2270/00; B32B 2307/7163; B32B 2307/7242; B32B 2307/7376

(57) ABSTRACT

A biodegradable laminating film having the layer structure A/B, wherein the 0.5 to 7 μm thick layer A comprises a polyurethane or acrylate adhesive; and wherein the 5 to 150 μm thick layer B comprises an aliphatic polyester and/or aliphatic-aromatic polyester, wherein the aliphatic-aromatic polyester is composed as follows: b1-i) 30 to 70 mol %, based on components b1-i and b1-ii, of a C6-C18 aliphatic dicarboxylic acid; b1-ii) 30 to 70 mol %, based on components b1-i and b1-ii, of an aromatic dicarboxylic acid; b1-iii) 98 to 100 mol %, based on components b1-i and b1-ii, of 1,3-propanediol or 1,4-butanediol; b1-iv) 0 to 2% by weight, based on components b1-i to b1-iii, of a chain extender and/or branching agent. The invention further relates to a food and/or beverage container comprising a substrate and a biodegradable laminating film coating, as the one described.

The present invention relates to a biodegradable laminating film having the layer structure A/B, wherein the 0.5 to 7 μm thick layer A comprises a polyurethane or acrylate adhesive; and wherein the 5 to 150 μm thick layer B comprises an aliphatic polyester and/or aliphatic-aromatic polyester, wherein the aliphatic-aromatic polyester is composed as follows:
b1-i) 30 to 70 mol %, based on components b1-i and b1-ii, of a _{C6-C18} dicarboxylic _{acid};
b1-ii) 30 to 70 mol %, based on components b1-i and b1-ii, of terephthalic acid;
b1-iii) 98 to 100 mol %, based on components b1-i and b1-ii, of 1,3-propanediol or 1,4-butanediol;
b1-iv) 0 to 2% by weight, based on components b1-i and b1-iii, of a chain extender and/or branching agent.

Furthermore, the invention relates to the use of the above-mentioned laminating film for coating substrates such as, in particular, paper or cardboard.

Specifically, the invention relates to the use of the film onto substrates to configure a food or beverage container. The container can be rigid, semi-rigid or flexible.

Packaging is used in particular in the food and beverage industry. They often consist of composite films bonded together by a suitable adhesive, at least one of the bonded films being a polymer film. There is a high demand for biodegradable composite film packaging that can be disposed of by composting after use.

Various approaches have been taken in the literature to date:

WO 2010/034712 describes a process for extrusion coating of paper with biodegradable polymers. As a rule, no adhesives are used in this process. The coated papers accessible by the process described in WO 2010/034712 are not suitable for every application due to limited adhesion to the paper, mechanical properties, barrier properties and biodegradation of the paper composite.

WO 2012/013506 describes the use of an aqueous polyurethane dispersion adhesive for the production of composite films that are partially industrially compostable. Degradation in industrial composting plants takes place under high humidity, in the presence of certain microorganisms and temperatures of about 55° C. The requirements for flexible packaging with regard to its biodegradability are constantly increasing, so that today the requirement for home compostability is frequently demanded for numerous applications. The composite films described in WO 2012/013506 do not sufficiently meet this criterion and are also not suitable for all flexible packaging applications in terms of their mechanical properties, and barrier properties.

The aim of the present invention was therefore to provide laminating films that are improved in terms of biodegradability, are preferably home compostable, have good adhesion to the substrate, preferably to paper, and also meet the other requirements.

Surprisingly, the laminating films described at the beginning of this article meet these criteria.

The invention is described in more detail below.

Layer A can also be referred to as the adhesive layer and provides the bond between layer B and the substrate. Layer A has a thickness of 0.5 to 7 μm and contains a polyurethane or acrylate adhesive.

Preferably, the adhesive in layer A consists essentially of at least one polyurethane dispersed in water as a polymeric binder and optionally additives such as fillers, thickeners, defoamers, etc. as described in detail in WO 2012/013506. The essential features of the polyurethane adhesive described in WO 2012/013506, to which express reference is made, are listed below:

The polymeric binder is preferably present as a dispersion in water or also in a mixture of water and water-soluble organic solvents with boiling points preferably below 150° C. (1 bar). Water is particularly preferred as the sole solvent. The water or other solvents are not included in the weight data for the composition of the adhesive.

Preferably, the polyurethane dispersion adhesive is biodegradable. Biodegradability within the meaning of this application is given, for example, if the ratio of gaseous carbon released in the form of _{CO2 to} the total carbon content of the material used after 20 days is at least 30%, preferably at least 60 or at least 80%, measured according to the ISO 14855 (2005) standard.

The polyurethanes preferably consist predominantly of polyisocyanates, in particular diisocyanates, on the one hand, and, as reactants, polyesterdiols and bifunctional carboxylic acids on the other. Preferably, the polyurethane is composed of at least 40% by weight, more preferably at least 60% by weight and very particularly preferably at least 80% by weight of diisocyanates, polyesterdiols and bifunctional carboxylic acids.

The polyurethane can be amorphous or semi-crystalline. If the polyurethane is semi-crystalline, the melting point is preferably less than 80° C. Preferably, the polyurethane contains polyester diols for this purpose in an amount of more than 10% by weight, more than 50% by weight or at least 80% by weight, based on the polyurethane. Particularly suitable are the polyurethane dispersions of BASF SE marketed under the trade name Epotal®.

Overall, the polyurethane is preferably built from:
a) Diisocyanates,
b) Diols, of which
b1) 10 to 100 mol %, based on the total amount of the diols (b), are polyesterdiols and have a molecular weight of 500 to 5000 g/mol,
b2) 0 to 90 mol %, based on the total amount of the diols (b), have a molecular weight of 60 to 500 g/mol,
c) at least one bifunctional carboxylic acid selected from dihydroxycarboxylic acids and diaminocarboxylic acids,
d) optionally further polyvalent compounds different from monomers (a) to (c) and containing reactive groups which are alcoholic hydroxyl groups, primary or secondary amino groups or isocyanate groups, and
e) optionally monovalent compounds different from monomers (a) to (d) and having a reactive group which is an alcoholic hydroxyl group, a primary or secondary amino group or an isocyanate group.

In particular, a home compostable adhesive in layer A as described in PCT/EP2021/054570 is preferred. The essential features of the polyurethane adhesive described in PCT/EP2021/054570, which are expressly referred to herein, are listed below:

The waterborne polyurethane dispersion adhesives of PCT/EP2021/054570 are suitable for making composite films that are biodegradable under home composting conditions (25±5° C.), wherein at least one layer B and a second substrate are bonded using the polyurethane dispersion adhesive A, and
wherein at least one of the substrates is a polymeric film that is biodegradable under home composting conditions, and wherein at least 60% by weight of the polyurethane consists of:
   (a) at least one diisocyanate
   (b) at least one polyesterdiol, and
   (c) at least one bifunctional carboxylic acid selected from dihydroxycarboxylic acids and diaminocarboxylic acids;
wherein the polyurethane has a glass transition temperature below 20° C. and either has no melting point above 20° C. or has a melting point above 20° C. with an enthalpy of fusion of less than 10 J/g, and
wherein preferably layer A of the polyurethane adhesive decomposes to greater than 90% by weight in _{CO2} and water under home composting conditions within 360 days; and wherein preferably layer A of the polyurethane adhesive is home compostable, and
wherein preferably the laminating film A/B produced therefrom is biodegradable under home composting conditions if at most 10% of the original dry weight of the material is present in a screen fraction >2 mm after aerobic composting at 25±5° C. for a period of at most 180 days.

Preferably, a film comprising the polyurethane adhesive, the layer B and/or the substrate and/or the composite film is home compostable.

Particularly suitable are the polyurethane dispersions from BASF SE marketed under the trade name Epotal® Eco.

The layer B according to the invention has a layer thickness of 5 to 150 μm and comprises an aliphatic polyester and/or aliphatic-aromatic polyester, the aliphatic-aromatic polyester being composed as follows:
b1-i) 30 to 70 mol %, based on components b1-i and b1-ii, of a _{C6-C18} dicarboxylic _{acid};
b1-ii) 30 to 70 mol %, based on components b1-i and b1-ii, of terephthalic acid;
b1-iii) 98 to 100 mol %, based on components b1-i and b1-ii, of 1,3-propanediol or 1,4-butanediol;
b1-iv) 0 to 2% by weight, based on components b1-i and b1-iii, of a chain extender and/or branching agent

Aliphatic polyesters are understood to mean, for example, the polyesters described in more detail in WO 2010/034711, to which express reference is made here.

The polyesters of WO 2010/034711 (i) are generally structured as follows:
i-a) 80 to 100 mol %, based on components i-a to i-b, of succinic acid;
i-b) 0 to 20 mol %, based on components i-a to i-b, of one or more _{C6-C20} dicarboxylic acids;
i-c) 99 to 102 mol %, preferably 99 to 100 mol %, based on components i-a to i-b, 1,3-propanediol or 1,4-butanediol;
i-d) 0 to 1% by weight, based on components i-a to i-c of a chain extender or branch;

The synthesis of the polyesters i of WO 2010/034711 is preferably carried out in a direct polycondensation reaction of the individual components. In this case, the dicarboxylic acid derivatives are directly reacted together with the diol in the presence of a transesterification catalyst to form the polycondensate of high molecular weight. On the other hand, a copolyester can also be obtained by transesterification of polybutylene succinate (PBS) with _{C6-C20 dicarboxylic acids} in the presence of diol. Zinc, aluminum and especially titanium catalysts are commonly used as catalysts. Titanium catalysts such as tetra(isopropyl)orthotitanate and in particular tetraisobutoxytitanate (TBOT) have the advantage over tin, antimony, cobalt and lead catalysts such as tin dioctanoate, which are frequently used in the literature, that residual amounts of the catalyst or downstream product of the catalyst remaining in the product are less toxic. This circumstance is particularly important in the case of biodegradable polyesters, since they are released directly into the environment.

In addition, the polyesters mentioned can be prepared by the methods described in JP 2008-45117 and EP-A 488 617. It has proved advantageous to first react components a to c to form a prepolyester with a VZ of 50 to 100 mL/g, preferably 60 to 80 mL/g, and then to react this with a chain extender i-d, for example with diisocyanates or with epoxide-containing polymethacrylates in a chain extension reaction to form a polyester i with a VZ of 100 to 450 ml/g, preferably 150 to 300 mL/g.

The acid component i-a used is 80 to 100 mol %. based on the acid components a and b, preferably 90 to 99 mol %, and more preferably 92 to 98 mol % succinic acid. Succinic acid is accessible by petrochemical means and preferably from renewable raw materials as described, for example, in EPA 2185682. EPA 2185682 discloses a biotechnological process for the production of succinic acid and 1,4-butanediol starting from different carbohydrates with microorganisms from the class Pasteurellaceae.

Acid component i-b is used in 0 to 20 mol %, preferably 1 to 10 mol %, and more preferably 2 to 8 mol % based on acid components i-a and i-b.

By C6-C20 dicarboxylic acids i-b is meant in particular adipic acid, succinic acid, azelaic acid, sebacic acid, brassylic acid and/or C18 dicarboxylic acid. Preferred are succinic acid, azelaic acid, sebacic acid and/or brassylic acid. The above-mentioned acids are accessible from renewable raw materials. For example, sebacic acid is accessible from castor oil. Such polyesters are characterized by excellent biodegradation behavior [Literature: Polym. Degr. Stab. 2004, 85, 855-863].

The dicarboxylic acids i-a and i-b can be used either as free acid or in the form of ester-forming derivatives. In particular, the di-C1- to C6-alkyl esters, such as dimethyl, diethyl, di-n-propyl, di-isopropyl, di-n-butyl, di-iso-butyl, di-t-butyl, di-n-pentyl, di-iso-pentyl or di-n-hexyl esters can be mentioned as ester-forming derivatives. Anhydrides of the dicarboxylic acids can also be used. The dicarboxylic acids or their ester-forming derivatives can be used individually or as a mixture.

The diols 1,3-propanediol and 1,4-butanediol are also accessible from renewable raw materials. Mixtures of the two diols can also be used. Due to the higher melting temperatures and better crystallization of the copolymer formed, 1,4-butanediol is preferred as the diol.

Usually, at the beginning of the polymerization, the diol (component i-c) is adjusted to the acids (components i-a and i-b) in a ratio of diol to diacids of 1.0:1 to 2.5:1 and preferably 1.3:1 to 2.2:1. Excess diol amounts are withdrawn during polymerization so that an approximately equimolar ratio is obtained at the end of polymerization. By approximately equimolar is meant a diacid/diol ratio of 0.98 to 1.00.

In one embodiment, 0 to 1% by weight, preferably 0.1 to 0.9% by weight, and more preferably 0.1 to 0.8% by weight, based on the total weight of components i-a to i-b, of a branching agent i-d and/or chain extender i-d′ are used. %, based on the total weight of components i-a to i-b, of a branching agent i-d and/or chain extender i-d′ selected from the group consisting of: a polyfunctional isocyanate, isocyanurate, oxazoline, carboxylic acid anhydride such as maleic anhydride, epoxide (in particular an epoxide-containing poly(meth)acrylate), an at least trifunctional alcohol or an at least trifunctional carboxylic acid. As a rule, no branching agents are used, only chain extenders.

Suitable bifunctional chain extenders include toluene-2,4-diisocyanate, toluene-2,6-diisocyanate, 2,2′-diphenylmethane diisocyanate, 2,4′-diphenylmethane diisocyanate, 4,4′-diphenylmethane diisocyanate, naphthylene-1,5-diisocyanate or xylylene diisocyanate, 1,6-hexamethylene diisocyanate, isophorone diisocyanate or methylene-bis (4-isocyanatocyclo-hexane). Isophorone diisocyanate and, in particular, 1,6-hexa methylene diisocyanate are particularly preferred.

Aliphatic polyesters i refer in particular to polyesters such as polybutylene succinate (PBS), polybutylene succinate-co-adipate (PBSA), polybutylene succinate-co-sebacate (PBSSe), polybutylene succinate-co-azelate (PBSAz) or polybutylene succinate-co-brassylate (PBSBr). The aliphatic polyesters PBS and PBSA are marketed, for example, by Mitsubishi under the name BioPBS®. More recent developments are described in WO 2010/034711.

The polyesters i generally have a number average molecular weight (Mn) in the range from 5000 to 100000, in particular in the range from 10000 to 75000 g/mol, preferably in the range from 15000 to 50000 g/mol, a weight average molecular weight (Mw) from 30000 to 300000, preferably 60000 to 200000 g/mol and an Mw/Mn ratio from 1 to 6, preferably 2 to 4. The viscosity number ranges from 30 to 450, preferably from 100 to 400 g/mL (measured in o-dichlorobenzene/phenol (weight ratio 50/50)). The melting point is in the range of 85 to 130, preferably in the range of 95 to 120° C. The MVR range according to DIN EN 1133-1 is in the range of 8 to 50 and especially 15 to 40 cm³/10 min (190° C., 2.16 kg).

Layer B aliphatic polyesters also include polyhydroxyalkanoates such as polycaprolactone (PCL), poly-3-hydroxybutyrate (PHB), poly-3-hydroxybutyrate-co-3-hydroxyvalerate (P(3HB)-co-P(3HV)), poly-3-hydroxybutyrate-co-4-hydroxybutyrate (P(3HB)-co-P(4HB)) and poly-3-hydroxybutyrate-co-3-hydroxyhexanoate (P (3HB)-co-P(3HH)) and in particular polylactic acid (PLA) are used.

Polylactic acid b2 with the following property profile is preferred:
a melt volume rate (MVR at 190° C. and 2.16 kg according to ISO 1133-1 EN of 0.5 to 100 and in particular of 5 to 50 cm³/10 minutes)
a melting point below 240° C.;
a glass point (Tg) greater than 55° C.
a water content of less than 1000 ppm
a residual monomer content (lactide) of less than 0.3%.
a molecular weight greater than 80 000 daltons.

Preferred polylactic acids are crystalline polylactic acid types from NatureWorks such as Ingeo® 6201 D, 6202 D, 6251 D, 3051 D, and 3251 D, and in particular 4043 D and 4044 D, as well as polylactic acids from Total Corbion such as Luminy® L175 and LX175 Corbion, and polylactic acids from Hisun such as Revode® 190 or 110. Total Corbion, such as Luminy® L175 and LX175 Corbion, and polylactic acids from Hisun, such as Revode® 190 or 110, but amorphous polylactic acid grades can also be suitable, such as Ingeo® 4060 D from NatureWorks.

Aliphatic-aromatic polyesters b1 in layer B are understood to be linear, chain-extended and optionally branched and chain-extended polyesters, as described, for example, in WO 96/15173 to 15176 or in WO 98/12242, to which express reference is made. Blends of different partially aromatic polyesters are also considered. Interesting recent developments are based on renewable raw materials (see WO 2010/034689). In particular, polyesters b1 include products such as ecoflex® (BASF SE).

Preferred polyesters b1 include polyesters containing as essential components:
b1-i) 30 to 70 mol %, preferably 40 to 60 and more preferably 50 to 60 mol %, based on components b1-i) and b1-ii), of an aliphatic dicarboxylic acid or mixtures thereof, preferably as described below: Adipic acid and in particular azelaic acid, sebacic acid and brassylic acid,
b1-ii) 30 to 70 mol %, preferably 40 to 60 and more preferably 40 to 50 mol %, based on components b1-i) and b1-ii), of an aromatic dicarboxylic acid or mixtures thereof, preferably as described below: terephthalic acid,
b1-iii) 98 to 100 mol %, based on components b1-i) and b1-ii), of 1,4-butanediol and 1,3-propanediol; and
b1-iv) 0 to 2% by weight, preferably 0.1 to 1% by weight, based on components b1-i) to b1-iii), of a chain extender, in particular a di- or polyfunctional isocyanate, preferably hexamethylene diisocyanate, and optionally a branching agent preferably: Trimethylolpropane, pentaerythritol and in particular glycerol.

Aliphatic diacids and the corresponding derivatives b1-i are generally those with 6 to 18 carbon atoms, preferably 9 to 14 carbon atoms. They can be both linear and branched.

Examples are: Adipic acid, azelaic acid, sebacic acid, brassylic acid and suberic acid (cork acid). The dicarboxylic acids or their ester-forming derivatives can be used individually or as a mixture of two or more of them.

Preferably, adipic acid, azelaic acid, sebacic acid, brassylic acid or their respective ester-forming derivatives or mixtures thereof are used. Particularly preferred are azelaic or sebacic acid or their respective ester-forming derivatives or mixtures thereof.

In particular, the following aliphatic-aromatic polyesters are preferred: polybutylene adipate-coterephthalate (PBAT), polybutylene adipate-co-azelate-terephthalate (PBAAzT) polybutylene adipate-co-sebacate-terephthalate (PBASeT), polybutylene azelate-coterephthalate (PBAZT) and polybutylene sebacate-coterephthalate (PBSeT), as well as mixtures of these polyesters.

Due to better home compostability according to Australian Standard AS 5810-2010 and ISO 14855-1 (2012), polybutylene adipate-co-azelate-terephthalate (PBAAzT) polybutylene adipate-co-sebacate-terephthalate (PBASeT) polybutylene azelate-co-terephthalate (PBAzT) and polybutylene sebacate-coterephthalate (PBSeT), and blends of polybutylene adipate-coterephthalate (PBAT) with polybutylene azelate-co-terephthalate (PBAzT) and polybutylene sebacate-coterephthalate (PBSeT) are particularly preferred.

The aromatic dicarboxylic acids or their ester-forming derivatives b1-ii can be used individually or as a mixture of two or more of them. Terephthalic acid or its ester-forming derivatives, such as dimethyl terephthalate, are particularly preferred.

The diols b1-iii—1,4-butanediol and 1,3-propanediol—are accessible as renewable raw materials. Mixtures of the named diols can also be used.

As a rule, 0 to 1% by weight, preferably 0.1 to 1.0% by weight and more preferably 0.1 to 0.3% by weight, based on the total weight of the polyester, of a branching agent and/or 0 to 1% by weight, preferably 0.1 to 1.0% by weight, based on the total weight of the polyester, of a chain extender (b1-vi) are used. Preferably, a di- or polyfunctional isocyanate, preferably hexamethylene diisocyanate, is used as chain extender and polyols such as preferably trimethylolpropane, pentaerythritol and, in particular, glycerol are used as branching agents.

The polyesters b1 generally have a number average molecular weight (Mn) in the range from 5000 to 100000, in particular in the range from 10000 to 75000 g/mol, preferably in the range from 15000 to 38000 g/mol, a weight average molecular weight (Mw) from 30000 to 300000, preferably 60000 to 200000 g/mol and an Mw/Mn ratio from 1 to 6, preferably 2 to 4. The viscosity number ranges from 50 to 450, preferably from 80 to 250 g/mL (measured in o-dichlorobenzene/phenol (weight ratio 50/50). The melting point is in the range of 85 to 150, preferably in the range of 95 to 140° C.

The MVR (melt volume rate) according to EN ISO 1133-1 EN (190° C., 2.16 kg weight) of the polyester b1 is generally 0.5 to 20, preferably 5 to 15 cm³/10 min. The acid numbers according to DIN EN 12634 are generally 0.01 to 1.2 mg KOH/g, preferably 0.01 to 1.0 mg KOH/g and particularly preferably 0.01 to 0.7 mg KOH/g.

As a rule, 0 to 25% by weight, in particular 3 to 20% by weight, based on the total weight of layer B, of at least one mineral filler b3 selected from the group consisting of: Chalk, graphite, gypsum, conductive carbon black, iron oxide, calcium sulfate, dolomite, kaolin, silicon dioxide (quartz), sodium carbonate, calcium carbonate, titanium dioxide, silicate, wollastonite, mica, montmorillonite and talcum. Preferred mineral fillers are silica, kaolin and calcium sulfate and especially preferred are: Calcium carbonate and talc.

A preferred embodiment of layer B includes:
b1) 60 to 100% by weight of an aliphatic-aromatic polyester selected from the group consisting of: Polybutylene adipate-coterephthalate, Polybutylene azelate-coterephthalate and Polybutylene sebacate-coterephthalate;
b2) 0 to 15% by weight, preferably 3 to 12% by weight, of a polyhydroxyalkanoate, preferably a polylactic acid;
b3) 0 to 25% by weight, preferably 3 to 20% by weight, of a mineral filler.

In one embodiment, layer B does not contain any lubricant or release agent. This embodiment exhibits very good compatibility with layer A up to layer thicknesses of 150 μm, so that the adhesion of the laminating film to the substrate, such as paper or board in particular, is very good. This is shown by the fact that fiber tearing occurs when an attempt is made to detach the film from the paper or board again.

In a further embodiment, layer B contains 0.05 to 0.3% by weight, based on the total weight of layer B, of a lubricant or release agent such as erucic acid amide or, preferably, stearic acid amide. This embodiment exhibits very good compatibility with layer A up to layer thicknesses of 50 μm, so that the adhesion of the laminating film to the substrate, such as paper or board in particular, is very good. This is shown by the fact that fiber tearing occurs when an attempt is made to detach the film from the paper or board again. If, on the other hand, lubricants or release agents such as behenic acid amide are used in layer B, poor compatibility with layer A is observed.

Furthermore, the compound of components i to v according to the invention may contain other additives known to the skilled person. For example, additives customary in plastics technology, such as stabilizers; nucleating agents, such as the mineral fillers b3 already mentioned above or also crystalline polylactic acid; release agents, such as stearates (in particular calcium stearate); plasticizers (plasticizers) such as citric acid esters (in particular acetyl tributyl citrate), glyceric acid esters such as triacetyl glycerol or ethylene glycol derivatives, surfactants such as polysorbates, palmitates or laurates; antistatic agents, UV absorbers; UV stabilizers; antifog agents, pigments or preferably biodegradable dyes Sicoversal® of Fa. BASF SE. The additives are used in concentrations of 0 to 2 wt. %, in particular 0.1 to 2 wt. %, based on layer B. Plasticizers may be present in 0.1 to 10 wt. % in the layer B according to the invention.

Most of the food and/or beverage in the food industry place high requirements on the oxygen barrier or aroma barrier. Here, a layered structure with an additional barrier layer C has proven to be advantageous. A suitable layer structure is, for example, A/B/C/B, where layers A and B have the previously mentioned meaning and layer C is a barrier layer consisting of polyglycolic acid (PGA), ethylene vinyl alcohol (EVOH) or preferably polyvinyl alcohol (PVOH).

The barrier layer C usually has a thickness of 2 to 10 μm and preferably consists of polyvinyl alcohol. A suitable PVOH is, for example, G-polymer from Mitsubishi Chemicals, in particular G-polymer BVE8049. Since the PVOH does not adhere sufficiently to the biopolymer layer B, the barrier layer is preferably composed of the individual layers C′/C/C′, with layer C′ representing an adhesion promoter layer. A suitable adhesion promoter is, for example, the copolymer BTR-8002P from Mitsubishi Chemicals. The adhesion promoter layer usually has a thickness of 2 to 6 μm. In these cases, the laminating film has an overall layer structure of, for example, A/B/C′/C/C′/B or B′.

Another suitable layer structure is A/B/C/B′, layers A, B and C having the meaning given above and layer B′ having a layer thickness of 10 to 100 μm and containing, in addition to the components mentioned for layer B, 0.2 to 0.5% by weight, based on the total weight of layer B′, of erucic acid amide, stearic acid amide or preferably behenic acid amide as lubricant or mold release agent.

The laminating films according to the invention are used for composite film lamination of a substrate selected from the group of biodegradable film, metal film, metallized film, cellophane or preferably paper products.

For the purposes of the present invention, the term “paper products” includes all types of paper and board.

Suitable fibers for the production of said paper products include all commonly used types, e.g., mechanical pulp, bleached and unbleached chemical pulp, paper pulp from any annual crop, and waste paper (including in the form of broke, either coated or uncoated). The above fibers may be used either alone or as any mixture of them to produce the pulps from which paper products are made. For example, the term wood pulp includes groundwood pulp, thermomechanical pulp (TMP), chemothermomechanical pulp (CTMP), compression wood pulp, semi-chemical pulp, high-yield chemical pulp, and refiner pulp (RMP). Exemplary chemical pulps include sulfate pulps, sulfite pulps, and soda pulps. Examples of suitable annual plants for pulp production include rice, wheat, sugarcane, and kenaf.

Amounts of 0.01 to 3% by weight, preferably 0.05 to 1% by weight, of sizing, in each case based on the solids content of the paper dry substance, are usually added to the pulps, varying according to the desired degree of sizing of the papers to be finished. The paper may also contain other substances, e.g. starch, pigments, dyes, optical brighteners, biocides, paper strengtheners, fixing agents, defoamers, retention agents and/or dewatering aids.

The composite films produced preferably have the following structure:
(i) a paper having a basis weight of from 30 to 600 g/m2, preferably from 40 to 400 g/m2, more preferably from 50 to 150 g/m2,
ii) the laminating film according to the invention having a total thickness of from 5.5 to 300 μm, preferably from 10 to 150 μm, and with particular preference from 15 to 100 μm.

A wide variety of materials can be used for the paper layers, e.g. white or brown kraftliner, pulp, waste paper, corrugated board or screenings.

The total thickness of the paper-film composite is usually between 31 and 1000 g/m2. A paper-film composite of 80-500 μm can preferably be produced by lamination, and a paper-film composite of 50-300 μm is particularly preferred by extrusion coating.

Within the laminated film according to the invention, the substrate (e.g. paper) has protection against mineral oil and other types of oil, as well as against grease and moisture, since the laminating film exerts a corresponding barrier effect. On the other hand, when the laminated films are used for food packaging, the food products have protection from the mineral oils and mineral substances present, for example, in the waste paper, since the laminating film exerts this barrier effect. Furthermore, since the laminated film can be sealed to itself as well as to paper, cardboard, cellophane and metal, it enables the production of, for example, coffee cups, beverage cartons or cartons for frozen products. Particularly suitable for food and/or beverage containers are capsules, pods, pouches, cartridges, or the like, and preferably comprising coffee and/or tea.

The composite film is particularly suitable for the production of paper bags for dry foods, e.g. coffee, tea, soup powder, sauce powder; for liquids; tubular laminates; paper carrier bags, paper laminates and coextrudates for ice cream, confectionery (e.g. chocolate and cereal bars) and paper tape; paper cups, yogurt pots; prepared food trays; wrapped paperboard (cans, drums), wet-strength cartons for outer packaging (wine bottles, groceries); coated paperboard fruit crates; fast-food plates; staple trays; beverage cartons and cartons for liquids, such as detergents and cleaning products, cartons for frozen products, ice cream packaging (e.g. e.g. ice cream cups, wrapping material) e.g. ice cream cups, wrapping material for conical ice cream cones); paper labels; flower pots and plant pots.

The composite films produced according to the invention are particularly suitable for the production of packaging, especially for food packaging.

Therefore, the invention provides for the use of the laminating film described herein in the manufacture of composite films that are biodegradable or preferably biodegradable under home composting conditions and wherein the composite film is part of a home compostable flexible package.

An advantage of the invention is that the laminating film used in accordance with the invention enables good adhesive bonding of different substances such as substrate and layer B to one another, giving the bonded composite a high strength. Furthermore, the laminated films produced according to the invention exhibit good biodegradability and, in particular, home compostability.

For the purposes of the present invention, the characteristic “biodegradable” is fulfilled for a substance or a mixture of substances if this substance or mixture of substances has a percentage degree of biodegradation of at least 90% after 180 days in accordance with DIN EN 13432.

In general, biodegradation results in the polyester (blend) decomposing in a reasonable and detectable period of time. Degradation can be enzymatic, hydrolytic, oxidative, and/or due to exposure to electromagnetic radiation, such as UV radiation, and is usually predominantly caused by the action of microorganisms such as bacteria, yeasts, fungi, and algae. Biodegradability can be quantified, for example, by mixing polyesters with compost and storing them for a certain time. For example, according to DIN EN 13432 (referring to ISO 14855), _{CO2-free} air is allowed to flow through mature compost during composting and this is subjected to a defined temperature program. Here, biodegradability is defined by the ratio of the net CO2 release of the sample (after subtracting the _{CO2 release by the} compost without sample) to the maximum _{CO2 release of the} sample (calculated from the carbon content of the sample) as the percentage degree of biodegradation. Biodegradable polyester (blends) usually show clear signs of degradation such as fungal growth, cracking and pitting after only a few days of composting.

Other methods for determining biodegradability are described, for example, in ASTM D 5338 and ASTM D 6400-4.

The present invention preferably provides laminating films or laminated films containing these laminating films which are biodegradable under home composting conditions (25±5° C.). Home compost conditions mean the laminating films or composite films are degraded to more than 90% by weight in _{CO2} and water within 360 days.

Home compostability is tested according to Australian Standard AS 5810-2010 or French Standard NF T 51-800 or ISO 14855-1 (2012) “Determination of ultimate aerobic biodegradability of plastics under controlled composting conditions-Method by analysis of evolved carbon dioxide” at ambient temperature (28 +2° C.) to simulate home composting conditions instead of the temperature of 58° C. described in ISO Standard 14855-1 (2012).

Features:

Glass transition temperatures were determined by differential scanning calorimetry (ASTM D 3418-08, “midpoint temperature” of the second heating curve, heating rate 20 K/min).

Melting points and enthalpy of fusion are determined according to DIN 53765 (1994) (melting point=peak temperature) by heating at 20 K/min after heating the polyurethane films to 120° C., cooling at 20 K/min to 23° C., annealing there for 20 hours.

### Source Materials

### Components of Layer A)

a-1) Epotal® Eco 3702 from BASF SE, waterborne polyurethane dispersion (see PCT/EP2021/054570)
a-2) Epotal® P 100 eco from BASF SE, aqueous polyurethane dispersion (see WO 2010/034712)

### Components of Layer B)

### Component b1):

b1-1) Polybutylene adipate-coterephthalate: ecoflex® F C1200 from BASF SE (MVR at 2.5-4.5 cm³/10 min (190° C., 2.16 kg)
b1-2) Polybutylene sebacate-coterephthalate: ecoflex® FS C2200 from BASF SE (MVR at 3-5 cm³/10 min (190° C., 5 kg)

### Component b2)

b2-1) Polylactic acid: (PLA) Ingeo® 4044 D from NatureWorks (MVR 1.5-3.5 cm³/10 min (190° C., 2.16 kg))

### Component b3)

b3-1) Plustalc H05C from the company Elementis
b3-2) Calcium carbonate from the company Omya

### Component b4)

b4-1) Erucaic acid amide: Crodamide™ ER from Croda International Plc.
b4-2) Stearic acid amide Crodamide SRV from the company Croda
b4-3) Behenic acid amide Crodamide BR from the company Croda

### Component b5)

b5-1) Joncryl® ADR 4468, glycidyl methacrylate from BASF SE

### Components of Layer C)

c-1 (C′) BTR-8002P Adhesion promoter from Mitsubishi Chemicals
c-2 G-polymer BVE8049 PvOH from Mitsubishi Chemicals

### Compounding of Layer B

The compounds listed in Table 1 were produced on a Coperion MC 40 extruder. The temperatures at the outlet were set to 250° C. The extrudate was then pelletized under water. Following pelletizing, the pellets were dried at 60° C.

TABLE 1
Composition of layer B

| | b1-1 | b1-2 | b2-1 | b3-1 | b3-2 | b4-1 | b4-2 | b4-3 | b5-1 |
|---|---|---|---|---|---|---|---|---|---|
| | Weight | Weight | Weight | Weight | Weight | Weight | Weight | Weight | Weight |
| | % | % | % | % | % | % | % | % | % |
| I | | 71.9 | 8 | 6 | 14 | | | | 0.1 |
| II | 88.4 | | 9 | | 2.4 | 0.1 | | | 0.1 |
| III | 90.7 | | 9 | | | | 0.2 | | 0.1 |
| IV | 87.7 | | 9 | 3 | | | 0.2 | | 0.1 |
| V | | 75.8 | 9 | 15 | | | | 0.2 | |
| VI | | 75.8 | 9 | 15 | | | 0.2 | | |
| VII | | 75.6 | 9 | 15 | | | 0.4 | | |
| VIII | | 76 | 9 | 15 | | | | | |

TABLE 2
Composition of the laminating film

| Exam- | A | B | | C′ | C | C′ | B/B′ | Liabil- |
|---|---|---|---|---|---|---|---|---|
| ple | 4 μm | μm | Tab. 1 | 4 μm | 8 μm | 4 μm | 17 μm | ity* |
| 1 | a-1) | 17 | VIII | | | | | + |
| 2 | a-1) | 100 | VIII | | | | | + |
| V-3 | a-1) | 200 | VIII | | | | | − |
| 4 | a-1) | 17 | VIII | c-1 | c-2 | c-1 | VIII | + |
| 5 | a-1) | 12 | I | | | | | + |
| 6 | a-1) | 12 | II | | | | | + |
| 7 | a-1) | 12 | III | | | | | + |
| 8 | a-1) | 12 | IV | | | | | + |
| V-9 | a-1) | 60 | IV | | | | | −/+ |
| V-10 | a-1) | 17 | V | | | | | − |
| 11 | a-1) | 17 | VI | | | | | + |
| 12 | a-1) | 17 | VI | c-1 | c-2 | c-1 | V | + |
| V-13 | a-1) | 17 | VII | | | | | − |

The base film B was fixed on the laboratory coating table with the corona pre-treated side up and the adhesive to be tested was coated directly onto the film using a squeegee. The adhesive A was dried for 2 minutes with a hot air blower, and then the laminating film was applied with a hand roller and pressed onto a paper of different thickness from 50 gsm to 130 gsm in the roller laminating station at 70° C., with a roller speed of 5 m/minute and a laminating pressure of 6.5 bar. The laminate was then cut into 15-millimeter-wide strips using a cutting template and subjected to various storage cycles. After storage, the laminate strip was pulled apart on the tensile testing machine and the force required to do so was recorded. The test was performed on a tensile testing machine at an angle of 90 degrees with a pull-off speed of 100 mm/min. The test strip was split open on one side, one of the now loose ends was clamped in the upper clamp, the other in the lower clamp of the tensile testing machine and the test started. The rating (+) indicated in the last column of Table 2 means: fiber tear observed. The rating (−) indicated in the last column means: No fiber tear observed. *The adhesion of the laminating film to the substrate (paper) was determined as follows:

The tests given in Table 2 show that laminating films containing no release agent b4 in the layer exhibit very good adhesion to the substrate paper up to a total layer thickness of the laminating film of approx. 150 μm. If erucic acid amide b4-1 or stearic acid amide b4-2 are used as release agents up to a concentration of 0.3 wt. %, very good adhesion to the substrate paper can be achieved up to a total layer thickness of the laminating films of approx. 50-60 μm. If, on the other hand, behenic acid amide b4-3 is used in a concentration of 0.2 to 0.3 wt. % as a release agent, adhesion to the paper is already inadequate at a laminating film thickness of 17 μm.

### Home Composting Test

Home compostability is tested according to French standard NF T 51-800 or ISO 14855-1 (2012) “Determination of ultimate aerobic biodegradability of plastics under controlled composting conditions—Method by analysis of evolved carbon dioxide” at ambient temperature (28±2° C.) to simulate home composting conditions instead of the described temperature of 58° C.

The home compostability of the approximately 60 μm thick laminating films of Examples 4 and 12 were investigated under the above conditions and complete (>90%) degradation of the films was observed after 116 days and 157 days, respectively. Thus, these films meet the criterion of home compostability according to the Australian Standard AS 5810-2010 and ISO 14855-1 (2012). It can therefore be assumed that the thinner films with layer structure A/B and a composition of layer B: I, V to VIII (see Table 1) are also home compostable.

1. A biodegradable laminating film having the layer structure A/B, wherein the 0.5 to 7 μm thick layer A comprises a polyurethane or acrylate adhesive; and wherein the 5 to 150 μm thick layer B comprises an aliphatic polyester and/or aliphatic-aromatic polyester, wherein the aliphatic-aromatic polyester is composed as follows:
b1-i) 30 to 70 mol %, based on components b1-i and b1-ii, of a C6-C18 aliphatic dicarboxylic acid;
b1-ii) 30 to 70 mol %, based on components b1-i and b1-ii, of an aromatic dicarboxylic acid;
b1-iii) 98 to 100 mol %, based on components b1-i and b1-ii, of 1,3-propanediol or 1,4-butanediol;
b1-iv) 0 to 2% by weight, based on components b1-i to b1-iii, of a chain extender and/or branching agent.

2. Laminating film according to claim 1, wherein layer B is composed of:
b1) 60 to 100% by weight of an aliphatic-aromatic polyester selected from the group consisting of: Polybutylene adipate-coterephthalate, Polybutylene azelate-coterephthalate and Polybutylene sebacate-coterephthalate;
b2) 0 to 15% by weight, preferably 3 to 12% by weight, of a polyhydroxyalkanoate, preferably a polylactic acid;
b3) 0 to 25% by weight, preferably 3 to 20% by weight, of a mineral filler.

3. A laminating film according to claim 1, wherein layer A is formed from an aqueous polyurethane dispersion, wherein at least 60% by weight of the polyurethane is composed of:
a1) at least one diisocyanate;
a2) at least one polyesterol;
a3) at least one bifunctional carboxylic acid selected from the group consisting of dihydroxycarboxylic acid and diaminocarboxylic acid; and
wherein the glass transition temperature of the polyurethane is below 20° C. or the melting point of the polyurethane is not above 20° C. and has an enthalpy of fusion below 10 J/G.

4. Laminating film according to claim 1, wherein layer B has a layer thickness of 10 to 50 μm and contains 0.05 to 0.3% by weight, based on the total weight of layer B, of erucic acid amide.

5. Biodegradable laminating film with the layer structure A/B/C/B, having the layer structure A/B, wherein the 0.5 to 7 μm thick layer A comprises a polyurethane or acrylate adhesive; and wherein the 5 to 150 μm thick layer B comprises an aliphatic polyester and/or aliphatic-aromatic polyester, wherein the aliphatic-aromatic polyester is composed as follows:
b1-i) 30 to 70 mol %, based on components b1-i and b1-ii, of a C6-C18 aliphatic dicarboxylic acid;
b1-ii) 30 to 70 mol %, based on components b1-i and b1-ii, of an aromatic dicarboxylic acid;
b1-iii) 98 to 100 mol %, based on components b1-i and b1-ii, of 1,3-propanediol or 1,4-butanediol;
b1-iv) 0 to 2% by weight, based on components b1-i to b1-iii, of a chain extender and/or branching agent and layer C is a barrier layer consisting of polyglycolic acid, ethylene vinyl alcohol-or preferably polyvinyl alcohol.

6. Laminating film according to claim 5, wherein the barrier layer consists of the individual layers C′/C/C′ and layer C is composed of polyvinyl alcohol and C′ is an adhesion promoter layer.

7-11. (canceled)
